(19) United States
(12) Patent Application Publication
(10) Pub. No.: US 2020/0023823 A1
(43) Pub. Date: Jan. 23, 2020

(54) Method for Generating Braking Power by Actuating at Least One Electric Braking Motor in a Vehicle Parking Brake

(71) Applicant: Robert Bosch GmbH, Stuttgart (DE)

(72) Inventors: Frank Baehrle-Miller, Schoenaich (DE); Toni Frenzel, Kanagawa (JP)

(21) Appl. No.: 16/495,215

(22) PCT Filed: Apr. 18, 2018
(86) PCT No.: PCT/EP2018/059927

§ 371 Date: Sep. 18, 2019

(30) Foreign Application Priority Data
Apr. 19, 2017 (DE) 10 2017 206 608.3
Apr. 17, 2018 (DE) 10 2018 205 811.3

(51) Int. Cl. B60T 8/32; B60T 13/74

(52) U.S. Cl. CPC B60T 8/321; B60T 17/221; B60T 13/746; B60T 13/741

(57) ABSTRACT

In a method for generating braking power by actuating at least one electric braking motor in a vehicle parking brake comprising two control devices, in the event of a failure of a first control device/braking motor unit, braking power is generated automatically via a second control device/braking motor unit if the vehicle speed is lower than a threshold value and/or if a characteristic value in the vehicle (e.g. the ignition status) indicates that the vehicle is at or is about to come to a standstill, but preferably only once a defined time interval has elapsed.

The invention relates to a method of generating braking power by actuating at least one electric braking motor in a vehicle parking brake.

### STATE OF THE ART

DE 10 2004 004 992 A1 describes a braking system for a vehicle comprising a hydraulic vehicle brake and an electromechanical parking brake with an electric brake. The braking motor of the parking brake is integrated into a wheel brake unit of the hydraulic vehicle brake. The electric braking motor displaces a brake piston towards a brake disc to hold the vehicle at a standstill. During a regular braking process while driving, the brake piston is applied by the brake pressure when the hydraulic brake is applied. The electric braking motor is controlled by a control unit of an ESP system (Electronic Stability Program).

DE 10 2007 059 685 A1 describes a system for operating an electromechanical parking brake for a vehicle comprising two control units for evaluating a driver's parking brake request. The two control units are connected to an actuator for actuating the parking brake. When a fault occurs, a control unit that is supplied with power controls the actuator in such a way that the vehicle is held in a parking position, provided that there is a corresponding driver parking brake request.

In EP 1 063 453 B1, a control device is described for implementing an automatic parking and roll away lock for a motor vehicle. The control device includes a control unit and an actuator controlled by the control unit when it is found that the driver has left the vehicle or wishes to leave based on sensor signals from a belt lock sensor, a seat occupancy sensor and/or a bonnet or boot flap opening sensor.

### DISCLOSURE OF THE INVENTION

By means of the method according the invention, braking power can be generated by actuating at least one electric braking motor in a vehicle parking brake. The braking power is used to hold the vehicle at standstill and to secure it against unintentional rolling away. Where appropriate, the vehicle parking brake may also be used to generate braking power while driving the vehicle, so as to reduce the speed of the moving vehicle, in particular in the low speed range, for example during a parking process carried out by the driver or automatically.

The vehicle parking brake to which the driving relates includes at least two control units by means of which at least one braking motor of the parking brake can be controlled. The braking motor is preferably disposed in a wheel brake unit and displaces a brake piston against a brake disc. Advantageously, the wheel brake unit is part of a hydraulic vehicle brake in the vehicle, wherein when the hydraulic vehicle brake is actuated the piston is displaced against the brake disc by the hydraulic brake pressure. In an alternative version, it is possible that the parking brake is embodied independently and separately from the hydraulic vehicle brake.

Two control unit/braking motor units are formed in the vehicle parking brake, each with a control unit and a braking motor. During the regular, fully functional operation of the parking brake, if there is a corresponding demand, which is either present as a driver's request or is generated by a driver assistance system, at least one control unit/braking motor unit is controlled to generate braking power. The parking brake control units communicate with each other so that information can be exchanged from one control unit to another.

With the method according to the invention, in the event of a failure of a first control unit/braking motor unit, the second control unit/braking motor unit is automatically set in operation by means of the second control unit for generating braking power. This generation of braking power takes place in an independent and automated manner without the driver acting, provided that, as an additional condition, the vehicle speed is below an assigned limit value and/or a characteristic variable in the vehicle indicates an existing or at least imminent vehicle standstill. Only in this case is the automatic control of the at least one braking motor carried out by means of the second, functional control unit, which forms the second control unit/braking motor unit together with a braking motor that is also functional. The additional condition ensures that the vehicle is already at a standstill or at least only at a relatively low speed below the speed limit.

As an alternative to considering the speed, the driving state variable of the vehicle corresponding to the speed can also be used, from which the vehicle speed can be concluded directly or indirectly. For example, it can be determined by an environmental sensor system whether or in what way the sensor information changes.

The consideration of the vehicle speed or a corresponding driving state variable is generally sufficient to determine the vehicle's standstill or low speed. In addition or alternatively, it may also be appropriate to analyze at least one characteristic variable in the vehicle from which an existing or imminent vehicle standstill can be concluded. Here, for example, the ignition state, the state of a door contact switch, the state of a seat occupancy detection unit or the state of a belt lock can be taken into account. For example, the ignition state “off” indicates a vehicle standstill, likewise an open vehicle door or an open trunk lid, which can be detected with an appropriate contact switch. From the seat occupancy detection unit, it can be determined whether the driver's seat is occupied, so that in the case of a manual driving mode, a vehicle standstill can be concluded in the case of an unoccupied driver's seat. The current state of the seat belt lock in the driver's seat also provides at least a supporting indication of the occupancy of the driver's seat, wherein an open seat belt lock allows the conclusion of an unoccupied driver's seat or at least a driver's intention to exit the vehicle.

The characteristic variables indicating the existing or imminent vehicle standstill may, where appropriate, be combined with the vehicle speed or the driving state variable corresponding to the vehicle speed or with each other, whereby a higher level of reliability is obtained in the detection of a vehicle standstill or imminent standstill.

In principle, it is sufficient to arrange exactly two control units and exactly one electric braking motor in the vehicle parking brake. In this case the first control unit/braking motor unit will be formed by the first control unit and the braking motor and the second control unit/braking motor unit will be formed by the second control unit and the braking motor, so that the braking motor is part of both control unit/braking motor units. In the event of a fault—in the event of a failure of a control unit or a communication line or power supply line to the control unit—a switchover is carried out to the other intact control unit, which forms the second control unit/braking motor unit together with the functioning braking motor, by means of which the braking power is automatically generated if the further conditions are met.

According to an advantageous design, a total of exactly two control units and exactly two braking motors are available in the parking brake. The first control unit and a first braking motor form the first control unit/braking motor unit and the second control unit and the braking motor form the second control unit/braking motor unit. Normally—with fully intact functionality of all components of the parking brake—both the first and second control unit/braking motor units can generate braking power for holding the vehicle or decelerating the vehicle. The two braking motors are preferably located on the left and right vehicle wheels on a common vehicle axle.

Here, it is advantageous that the control units communicate with each other and that information is passed from one control unit to the other control unit. For example, it is possible that the first control unit forms a master control unit and the second control unit forms a slave control unit, wherein the master control unit, when the components of the parking brake are fully functional, analyzes the vehicle state or the driving state, for example the vehicle speed and the driver's request to actuate the parking brake, and forwards this information to the slave control unit, whereupon both control unit/braking motor units are preferably operated in a synchronous manner. In this case, the parking brake can be applied to build up the braking power, can be released to remove braking power or can remain without control.

In the event of a fault whereby a control unit/braking motor unit is no longer available or communication between the control units is disrupted, wherein the unavailability may involve both a fault in a control unit and a fault in a braking motor, the remaining intact control unit/braking motor unit will automatically generate braking power, provided that the additional condition is met with regard to vehicle speed or existing or imminent vehicle standstill. For example, in the event of disturbed communication between the control units, only the control unit/braking motor unit with the master control unit is controlled for generating braking power. Alternatively, in the event of disrupted communication between the control units, only the control unit/braking motor unit with the slave control unit can be controlled for generating braking power, or, according to another alternative, both the master control unit and the slave control unit are controlled independently of each other to generate braking power.

If there is a fault in a control unit or in a braking motor, the other control unit/braking motor unit, which is still intact, will be activated for the actual generation of braking power. Here, the intact control unit controls the intact braking motor assigned to it.

Where the vehicle speed or a corresponding driving state variable is considered for the decision as to whether braking power is automatically generated via the second control unit/braking motor unit in the event of a failure of a control unit/braking motor unit, information about the vehicle speed is preferably determined by means of a sensor system carried in the vehicle, for example the sensor system of an ESP system (Electronic Stability Program).

According to a further advantageous embodiment, the automatic braking power generation is carried out only after a defined period of time has elapsed since the detection of the vehicle standstill. With this time-delayed actuation of the second, intact control unit/braking motor unit, the advantage is achieved that, for example, during maneuvering operations, the parking brake does not generate braking power until the parking process is completed. This applies both to parking carried out by the driver and to automated parking, where the driver may even be outside the vehicle. Due to the time-delayed activation of the braking power, such parking operations can be carried out comfortably.

The amount of time that must elapse since the vehicle's standstill so that braking power is generated automatically can either be specified as fixed, for example at two seconds, or can be determined depending on other driving state variables or other characteristic variables in the vehicle. Furthermore, it is possible that the time period representing a time-delay is different in the case of a parking operation carried out by the driver and an automated parking process, wherein advantageously the time delay for a parking process carried out by a driver is longer than for a parking process that is performed automatically.

According to another advantageous embodiment, the braking power is automatically removed again after the automatic braking power generation, provided that a wish to drive off is detected. Such a wish to drive off exists, for example, if the drive torque in the vehicle exceeds an assigned limit value. This version increases the availability of the vehicle even in the event of a fault in the vehicle parking brake. The braking power generated by the parking brake is automatically reduced again so that the vehicle can be moved as desired.

For example, one of the control units is the control unit that is part of the hydraulic brake, such as the ESP control unit (Electronic Stability Program), by means of which valves in the hydraulic vehicle brake and a hydraulic pump in the braking system can be controlled. The ESP control unit performs the additional function as a control unit in a control unit/braking motor unit. It is in particular the master control unit in this case.

The second control unit is advantageously also a control unit of the hydraulic vehicle brake, for example a control unit of an electrically actuatable brake booster in the hydraulic vehicle brake such as an iBooster. Said second control unit is part of the second control unit/braking motor unit and in particular performs the function of the slave control unit.

The invention also relates to a control unit system or a combination of at least two control units for controlling the adjustable components of the parking brake, in particular the preferably two electric braking motors.

Furthermore, the invention relates to a vehicle parking brake for holding the vehicle at a standstill with at least two control units and at least one braking motor, preferably two braking motors, which can be controlled by means of a control unit. The at least one electric braking motor displaces a brake piston towards a brake disc to generate braking power.

The vehicle parking brake may be a part of a braking system for a vehicle which also includes a hydraulic brake. Advantageously, the hydraulic brake pressure of the vehicle brake and the electric braking motor of the parking brake act on the same brake piston.

Furthermore, the invention relates to a vehicle with a previously described vehicle parking brake. In a further embodiment, the invention relates to a vehicle with a braking system comprising a hydraulic vehicle brake and the previously described vehicle parking brake.

The invention also relates to a computer program product with a program code, which is designed to perform the aforementioned process steps. The computer program product runs in the control units.

Further advantages and expedient designs can be found in the further claims, the description of the figures and the drawings. In the figures:

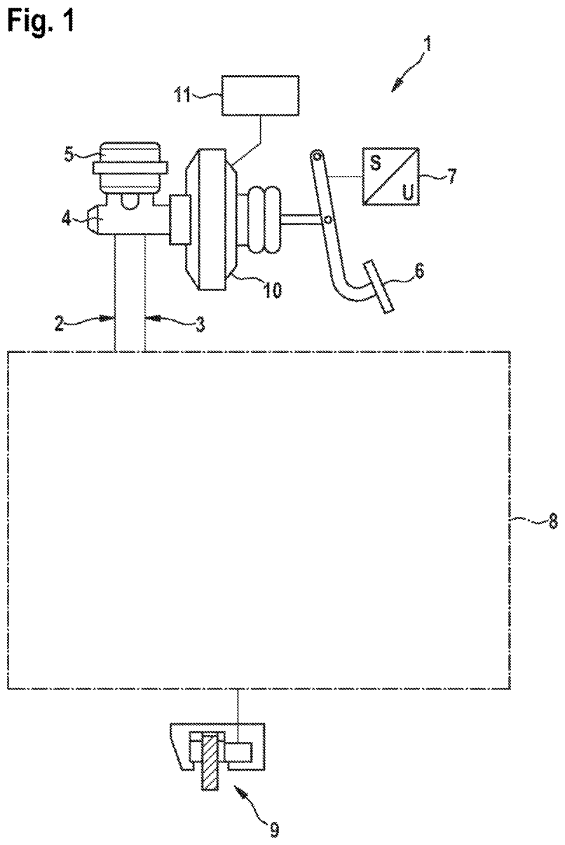

FIG. 1 shows a schematic representation of a hydraulic vehicle brake with wheel brake units that are additionally equipped with an electric braking motor as part of a parking brake,

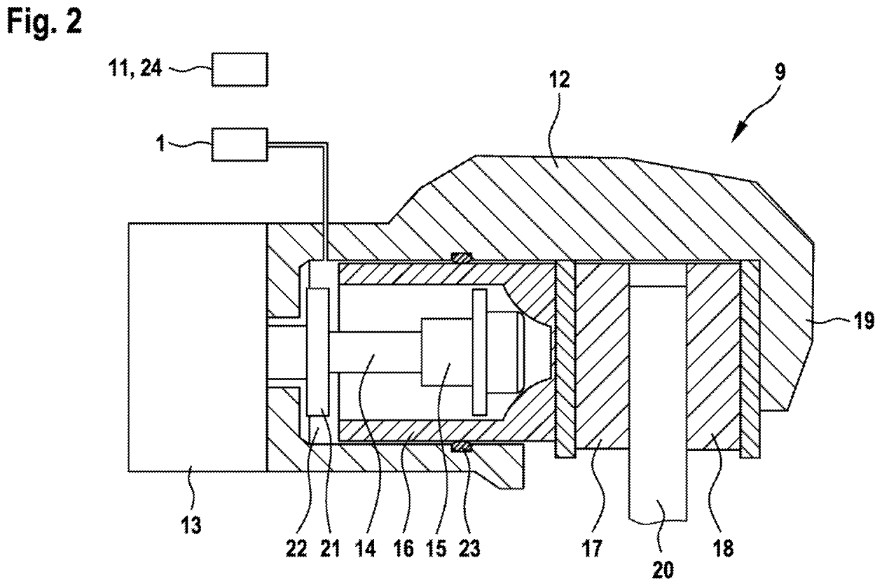

FIG. 2 shows a section through a parking brake with an electric braking motor,

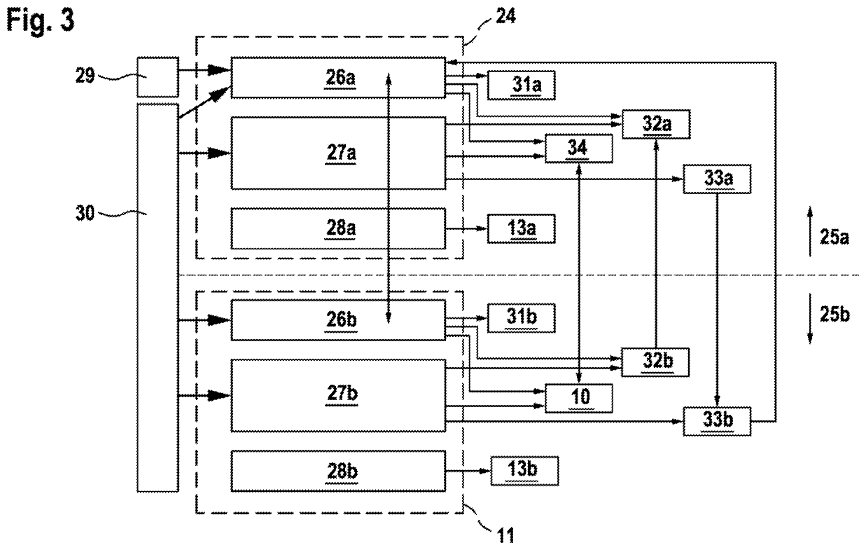

FIG. 3 shows a basic representation of the parking brake with two electric braking motors and one control unit each,

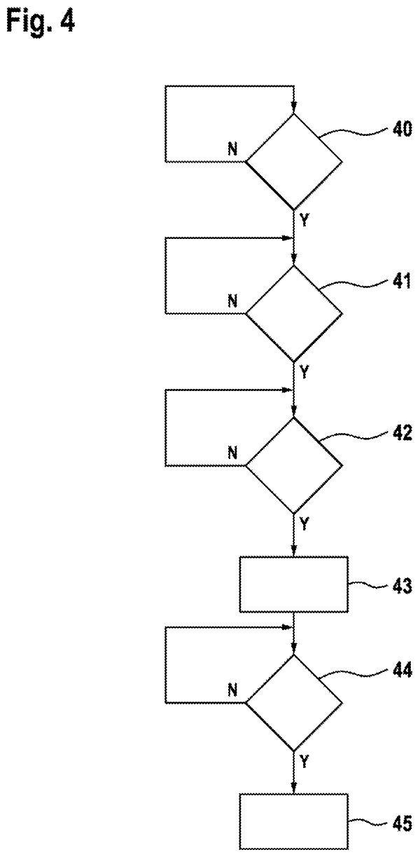

FIG. 4 shows a flow chart with process steps for generating braking power by applying the parking brake if a component of the parking brake has failed.

In the figures, the same components are provided with the same reference characters.

The braking system represented in FIG. 1 for a vehicle comprises a hydraulic vehicle brake 1 with a front axle brake circuit 2 and a rear axle brake circuit 3 for supplying and controlling wheel brake units 9 on each wheel of the vehicle with brake fluid under hydraulic pressure. The brake circuits may also be formed as two diagonal brake circuits, each with a front wheel and a diagonally arranged rear wheel.

The two brake circuits 2, 3 are connected to a common master brake cylinder 4, which is implemented as a tandem cylinder and is supplied with brake fluid via a brake fluid reservoir 5. The main brake cylinder piston inside the master brake cylinder 4 is operated by the driver by means of the brake pedal 6, wherein the pedal travel exerted by the driver is measured by a pedal travel sensor 7. Between the brake pedal 6 and the master brake cylinder 4 there is a brake booster 10, which includes, for example, an electric motor, which operates the master brake cylinder 4 via a gearbox (iBooster). The brake booster 10 is an active brake component for influencing the hydraulic brake pressure.

The control movement of the brake pedal 6 measured by the pedal travel sensor 7 is transmitted as a sensor signal to a control unit 11 of the braking system, in which control signals are generated for controlling the brake booster 10. The wheel brake units 9 are supplied with brake fluid in each brake circuit 2, 3 via different switching valves, which together with other units are part of the brake hydraulics 8. The brake hydraulics 8 also include a hydraulic pump, which is part of an electronic stability program (ESP) to which another control unit is assigned. The hydraulic pump is also an active brake component for influencing the hydraulic braking pressure.

In FIG. 2 a wheel brake unit 9, which is disposed on wheels on the rear axle of the vehicle, is shown in detail. The wheel brake unit 9 is part of the hydraulic brake 1 and is supplied with brake fluid 22 from the rear axle brake circuit. The wheel brake unit 9 also comprises an electromechanical braking device which is part of a holding or parking brake for holding a vehicle but can also be used to slow down the vehicle when the vehicle is moving, in particular at lower vehicle speeds below the speed limit. Such wheel brake units 9 may also be disposed, where appropriate, on the wheels of the front axle of the vehicle.

The electromechanical braking device comprises a brake caliper 12 with a claw 19 that engages around a brake disc 20. As a control element, the braking device has a motor-gear unit with a DC electric motor as a braking motor 13, the rotor shaft of which rotationally drives a spindle 14 on which a spindle nut is mounted 15 rotationally fixedly. When the spindle 14 is rotated, the spindle nut is displaced 15 axially. The spindle nut 15 moves within a brake piston 16 that is the carrier of a brake pad 17 that is pressed against the brake disc 20 by the brake piston 16. On the opposite side of the brake disc 20 there is another brake pad 18, which is held stationary on the claw 19. The brake piston 16 is sealed pressure-tight on its outside relative to the accommodating housing by an enclosing sealing ring 23.

When the spindle 14 is rotating the spindle nut 15 can move axially forwards within the brake piston 16 towards the brake disc 20 or can move axially rearwards until reaching an end stop 21 during an opposite rotational movement of the spindle 14.

To generate clamping power, the spindle nut 15 acts on the inner end face of the brake piston 16, whereby the axially movable brake piston 16 is pressed with the brake pad 17 against the facing end face of the brake disc 20. The spindle nut 15 is a transmission element between the braking motor and the brake piston.

For hydraulic braking power, the hydraulic pressure of the brake fluid 22 from the hydraulic vehicle brake 1 acts on the brake piston 16. The hydraulic pressure may also be effective with the vehicle at a standstill when the electromechanical braking device is operated in support, so that the total braking power is composed of the electromotive component and the hydraulic component. While the vehicle is travelling, either only the hydraulic brake is active, or both the hydraulic brake and the electromechanical braking device are active or only the electromechanical braking device is active to generate braking power. The control signals for controlling both the adjustable components of the hydraulic vehicle brake 1 as well as the electromechanical braking device are generated in the control unit 11, 24, which is the control unit 11 of the brake booster 10 (iBooster), or the ESP control unit 24.

The parking brake contains an electromechanical braking device in accordance with FIG. 2 on each of the vehicle's two rear wheels. The ESP control unit 24 is assigned to a braking device, for example on the left rear wheel, wherein the control unit 11 of the brake booster 10 is assigned to the other braking device.

In FIG. 3 the parking brake is shown schematically. The parking brake comprises the two electromechanical braking devices 25a and 25b on the left and right rear wheels of the vehicle, wherein a respective electric braking motor 13a, 13b belongs to each electromechanical braking device 25a, 25b. The braking device 25a is, for example, the braking device on the left rear wheel and the braking device 25b is the braking device on the right rear wheel of the vehicle.

The braking device 25a includes the ESP control unit 24 and the braking device 25b includes the iBooster control unit 11 to control the respective braking motors 13a or 13b. Each control unit 11, 24 comprises a standstill management unit 26a, 26b, a logic unit 27a, 27b and a hardware unit 28a, 28b. The standstill management unit 26a, 26b receives signals from other units 29 and 30 in the vehicle, wherein the unit 29 is a parking brake switch and the unit 30 is a vehicle sensor or a vehicle environment sensor. The standstill management unit 26a in the ESP control unit 24 receives signals from both the parking brake switch 29 and the sensor system 30. The standstill management unit 26b of the iBooster control unit 11, on the other hand, receives only signals of the sensor system 30, but not of the parking brake switch 29.

The logic unit 27a, 27b in the control unit 11, 24 contains the control logic for controlling the respective braking motors 13a, 13b and is implemented in particular as software in the control units.

The hardware units 28a, 28b include the power electronics for application to the braking motors 13a, 13b, for example H-bridges.

By actuating the parking brake switch 29, the driver can manually generate a trigger signal for activating the parking brake with both electromechanical braking devices 25a and 25b. The trigger signal of the parking brake switch 29 is fed to the standstill management unit 26a in the ESP control unit 24 as an input signal. The trigger signal is normally transmitted—in the case of full functionality of both control units 11, 24—from the standstill management unit 26a of the ESP control unit 24 to the standstill management unit 26b of the iBooster control unit 11, so that the trigger signal is available in both control units 11, 24 and the relevant electric braking motors 13a, 13b are controlled accordingly by both control units 11, 24.

In the event of a failure of a control unit, the respective braking motor also fails, but the functionality of the other electromechanical braking device remains, provided that the second control unit remains intact.

In the event of a failure of the iBooster control unit 11, if there is a trigger signal the first electromechanical braking device 25a is controlled by the ESP control unit 24, which acts on the electric braking motor 13a by means of the power electronics 28a.

In the event of a failure of the ESP control unit 24, the second electric braking motor 13b of the second electromechanical braking device 25b can be controlled by the iBooster control unit 11. However, in this case, the trigger signal of the parking brake switch 29 is not available, so that an alternative trigger signal must be generated, which is obtained from the vehicle sensor system or the vehicle environment sensor system 30. For example, information about the vehicle's standstill can be obtained from the vehicle's drive engine or from the environment sensors and can be used as a trigger signal.

If necessary, the sensor system 30 also includes another input system in the vehicle, for example a touch-sensitive screen, by means of which the driver can trigger the actuation of the parking brake independently of the parking brake switch 29.

Various other units can also be controlled by the control units 11, 24. For example, brake lights 31a, 31b can be operated when actuating one or both electromechanical braking devices 25a, 25b. Further communication between the braking devices 25a, 25b takes place via interface units 32a, 32b. Each control unit also provides information to a respective diagnostic unit 33a, 33b. In the case of an automatic parking operation or in the case of other braking operations where appropriate, the ESP control unit 24 can be used to provide a hydraulic braking power boost by means of the ESP pump 34 and the iBooster control unit 11 can be used to provide an electromechanical boost by means of the brake booster or the iBooster 10.

Each control unit 11, 24 with an assigned braking motor forms a control unit/braking motor unit for generating braking power, in particular for holding the vehicle at a standstill. In the event of a failure of a control unit/braking motor unit, the remaining intact control unit/braking motor unit can generate braking power. The failure in one of the control unit/braking motor units may include both the associated control unit and the associated braking motor. In addition, it is possible that the communication between the control units 11, 24 is interrupted, so that no signal can be transmitted from the control unit 24 to the control unit 11.

In FIG. 4 a flow chart with various process steps for generating braking power by actuating the parking brake in the event that a control unit/braking motor unit or communication between the control units has failed is shown in detail. The procedure automatically activates the remaining control unit/braking motor unit, provided that the vehicle speed is below a limit value or that a characteristic variable in the vehicle indicates an existing or imminent vehicle standstill.

According to FIG. 4, first, in a first process step 40, a checked is made as to whether a control unit/braking motor unit has failed or the communication between the control units is interrupted. The failure of a control unit/braking motor unit may relate to both the failure of a control unit and the failure of a braking motor or an interruption in signal and current transmission. If the check in the first process step 40 shows that there is in fact a failure of a control unit/braking motor unit or an interruption of communication between the control units, the Yes branch (“Y”) is consequently advanced to the next process step 41. Otherwise, the full functionality is available, and the No branch (“N”) is consequently returned to the check according to process step 40, which is re-run at cyclic intervals.

In process step 41, which is passed through in the event of a fault in the parking brake, a query is carried out as to whether the vehicle speed or a corresponding driving state variable is less than an assigned limit value. The limit value is advantageously of the order of 10 km/h.

In addition or alternatively to considering the driving state variable, a characteristic variable can also be considered that indicates an existing or imminent vehicle standstill, for example the ignition state of the drive engine in the vehicle, the state of a door contact switch, in particular on the driver's door, the state of a seat occupancy detection unit for the driver's seat or the state of a seat belt lock for the driver's belt. It is also possible to take into account the state of a contact switch on the trunk. If the corresponding characteristic variable indicates a stationary vehicle or an imminent vehicle standstill, for example with the driver's door open or the boot lid open, this information may also be used for the method according to the invention of automatic control of the intact control unit/braking motor unit. In a preferred design, both the vehicle speed is checked for being below the assigned limit value and one or more parameters indicating an existing or imminent vehicle standstill will be taken into account. This increases reliability and plausibility with regard to the automatic generation of braking power.

If the query in step 41 shows that the vehicle speed has not fallen below the assigned limit value and/or the parameters in the vehicle under consideration do not indicate an existing or imminent vehicle standstill, then consequently the No branch is returned to the beginning of process step 41 and this step is re-run at cyclic intervals. Otherwise, if a condition or the various conditions in step 41 are met, the Yes branch is consequently advanced to the next step 42.

If the yes output of the query is reached in process step 41, the conditions are in principle met that the intact control unit/braking motor unit can be activated automatically, and the braking power can be generated. For comfort reasons, however, a further time delay is taken into account, which is the subject of the process step 42. In this case, waiting for a defined period of time after the detection of the vehicle's standstill is carried out before the braking power is automatically generated by the control unit/braking motor unit. By waiting for the time period in process step 42, a higher degree of driving comfort is achieved, especially during a parking or unparking process in the vehicle.

If the query in step 42 shows that a defined time span has not yet elapsed, the No branch returns to the beginning of step 42 and this step 42 is re-run at cyclic intervals. If, on the other hand, the query shows that the defined period of time has elapsed, the Yes branch is consequently moved to the next process step 43, in which the intact control unit/braking motor unit is activated, and braking power is generated automatically.

In the following process step 44, conditions are queried that lead to a discontinuation of the braking power generation by the parking brake. The automatic braking power generation by the parking brake is also automatically removed again if one or more corresponding termination conditions are met, which are checked in process step 44. This is the drive torque of the drive engine in the vehicle, for example. If the drive torque does not exceed an assigned limit value, the braking power of the parking brake is maintained and consequently the No branch is again returned to the beginning of the query in step 44 and the query is re-run at cyclic intervals. If, on the other hand, the query in step 44 indicates that the drive torque exceeds the assigned limit value, it must be assumed that the vehicle journey is to be resumed, whereupon the Yes branch is consequently advanced to the step 45 and the braking power of the parking brake is automatically removed again.

1. A method for generating braking power, the method comprising:
actuating at least one electric braking motor in a vehicle parking brake of a vehicle, the vehicle parking brake having at least two controllers configured to control at the least one electric braking motor; and
automatically activating, in response to a failure of a first controller-braking motor pair, a second controller-braking motor pair to generate braking power if at least one of (i) one of a vehicle speed of the vehicle and a corresponding driving state variable of the vehicle is less than an assigned limit value, and (ii) a characteristic variable of the vehicle indicates one of an existing vehicle standstill and an imminent vehicle standstill.

2. The method as claimed in claim 1, wherein:
a first controller of the at least two controllers and a first electric braking motor of the at least one electric braking motor form the first controller-braking motor pair; and
a second controller of the at least two controllers and a second electric braking motor of the at least one electric braking motor form the second first controller-braking motor pair.

3. The method as claimed in claim 2, wherein:
the first controller is a master controller and the second controller is a slave controller; and
the master controller is configured to, after evaluation of a vehicle state of the vehicle, forward control information to the slave controller.

4. The method as claimed in claim 1, wherein the characteristic variable indicating the one of the existing vehicle standstill and imminent vehicle standstill is at least one of an ignition state of the vehicle, a state of a door contact switch of the vehicle, a state of a seat occupancy detector of the vehicle, and a state of a belt lock of the vehicle.

5. The method as claimed in claim 1, wherein the one of the existing vehicle standstill and imminent vehicle standstill is detected in response to both (i) the one of the vehicle speed and the corresponding driving state variable being less than the assigned limit value and (ii) the characteristic variable adopting a value indicating the one of the existing vehicle standstill and imminent vehicle standstill.

6. The method as claimed in claim 5, wherein the automatically activating the second controller-braking motor pair to generate braking power occurs only after a defined period of time has elapsed since detecting the one of the existing vehicle standstill and imminent vehicle standstill.

7. The method as claimed in claim 5, further comprising:
automatically removing, following the automatically activating the second controller-braking motor pair to generate braking power, the braking power in response to detecting a wish to drive off.

8. The method as claimed in claim 7, wherein the wish to drive off is detected in response to a drive torque of the vehicle exceeding an assigned limit value.

9. A vehicle parking brake for holding a vehicle at a standstill, the vehicle parking brake comprising:
at least one electric braking motor; and
at least two controllers configured to:
actuate the at least one electric braking motor; and
automatically activate, in response to a failure of a first controller-braking motor pair, a second controller-braking motor pair to generate braking power if at least one of (i) one of a vehicle speed of the vehicle and a corresponding driving state variable of the vehicle is less than an assigned limit value, and (ii) a characteristic variable of the vehicle indicates one of an existing vehicle standstill and an imminent vehicle standstill.

10. The vehicle parking brake as claimed in claim 9, wherein the at least one electric braking motor is configured to displace a brake piston towards a brake disc.

11. The vehicle parking brake as claimed in claim 9, wherein the vehicle parking brake is part of a braking system that also includes a hydraulic brake.

12. The vehicle parking brake as claimed in claim 11, wherein the braking system is part of a vehicle.

13. A vehicle comprising:
a vehicle parking brake configured to hold the vehicle at a standstill, the vehicle parking brake comprising:
at least one electric braking motor; and
at least two controllers configured to:
actuate the at least one electric braking motor; and
automatically activate, in response to a failure of a first controller-braking motor pair, a second controller-braking motor pair to generate braking power if at least one of (i) one of a vehicle speed of the vehicle and a corresponding driving state variable of the vehicle is less than an assigned limit value, and (ii) a characteristic variable of the vehicle indicates one of an existing vehicle standstill and an imminent vehicle standstill.

14. The method as claimed in claim 1, wherein the method is performed by the at least two controllers by executing a computer program stored on a non-transitory computer readable medium.
